(19) United States
(12) Patent Application Publication
(10) Pub. No.: US 2014/0209841 A1
(43) Pub. Date: Jul. 31, 2014

(54) COMPOSITION OF BIODEGRADABLE/BIO-PLASTIC MATERIAL AND USING THE SAME TO MAKE CONSUMABLE PRODUCTS

(71) Applicant: DALE SINGH TAUNK, FREMONT, CA (US)

(72) Inventor: DALE SINGH TAUNK, FREMONT, CA (US)

(73) Assignee: ALPHAGEM BIO INC., FREMONT, CA (US)

(21) Appl. No.: 14/146,554

(22) Filed: Jan. 2, 2014

Related U.S. Application Data
(60) Provisional application No. 61/759,384, filed on Jan. 31, 2013.

(51) Int. Cl. C08L 23/12; C08L 23/14; C08L 3/00; C08L 97/02; C08L 1/00; C08L 89/00; C08L 67/04; C08L 69/00

(52) U.S. Cl. CPC C08L 23/12; C08L 67/04; C08L 23/14; C08L 69/00; C08L 97/02; C08L 1/00; C08L 89/00; C08L 3/00
USPC 252/511; 525/185; 524/15; 524/13

(57) ABSTRACT

A biodegradable bio-plastic material composition comprising of synthetic materials and biological/natural/second natural reusable material is described. The use of natural material that is easily degradable in landfill makes it easy to dispose the article and reduce green gas emission in the environment. Biological reusable materials may be one of polylactic acid based plastic, walnut, almond, coconut and other hard shells, hard skins from rice, wheat, flax, and other seeds, corn husks, and other organic biodegradable matter and synthetic materials may be polypropylene and/or polyethylene.

### CROSS REFERENCE TO RELATED PENDING APPLICATIONS

This application is a Utility application and claims priority to U.S. Provisional Application No. 61/759,384 filed on 31^{st} Jan. 2013. The pending U.S. Provisional Application No. 61/759,384 is hereby incorporated by reference in its entireties for all of its teachings.

### FIELD OF INVENTION

The present disclosure is generally directed to a biodegradable bio-plastic material to make consumer goods. More specifically the composition of biodegradable bio-plastic material is used for making laboratory consumables.

### BACKGROUND

Conventional lab products are made up of synthetic materials and once they are discarded in the garbage dumps they take a long time to decompose and degrade. This increases the green gas effect and affects the environment. However, to overcome these deficiencies, to reduce waste, a low cost alternative and to further protect the environment a better solution needs to be proposed.

### SUMMARY

The present disclosure provides the composition and use of a biodegradable bio-plastic material which makes it possible for consumable products to be green and is beneficial for the environment in several key areas.

In one embodiment, the biodegradable/bio-plastic material is a combination of two or more materials. Throughout the application a first material, a second material and a third material are discussed. One of the materials is a natural material. The other material is a synthetic material. There are many natural materials. There is a first material that is made with a natural material and is hydrophilic or hydrophobic in nature. This first material has a specific tensile strength. In one embodiment, a second material may also be made as a byproduct of a natural material. In another embodiment, a combination of first material and a second material may be used to make consumable products. In another embodiment a first material that is natural material and a synthetic material may be combined to make a consumable product. In yet another embodiment, a first material, a second material and a synthetic material may be combined to make a consumable product. In one embodiment it could be a bio-plastic material made up of a natural material and a synthetic material. In another embodiment, a first material is synthetic and second material is a plastic made up of a natural material that is combined to make a biodegradable bio-plastic material. In another embodiment, a third material may be used that has conductive properties.

A formulation for this biodegradable bio-plastic may be a percentage by weight or volume. In one embodiment, the natural material or bio matter or a hydrophilic matter may be present in greater than 0% and less than 80% by weight and or volume. The synthetic material or hydrophobic may be less than 100% and greater than 20% by weight and or volume. There is more combination described in detailed description section below.

In another embodiment, a synthetic material is 0.001-99% of the composition. The bio-material (biological material/first material/second material) is between 0.001-20%. In another embodiment there might be combination of two synthetic materials and two natural materials.

In one embodiment, manufacturing methods that will be used for making the consumables such as laboratory disposables or products from this biodegradable bio-plastic material are injection molding, injection blow molding, extrusion, and rotational molding, but not limited to these. The laboratory product that may be made by this material composition is at least one of a Pipette tips, Pipette racks, Pipette rack covers both on top and bottom, Pipette packaging material, storage racks, freezer racks, Micro centrifuge tube, Centrifuge tubes with 5 ml, 15 ml, 50 ml capacity, Screw cap sample storage tube, PCR sample tube, PCR strip, PCR plates 24 well, 48 well, 96 well, 384 well, 1536 well, Reservoir plate 1 well to 96 well, Assay plates 96 well, 384 well, 1536 well, 3456 well, 6144 well, Elisa micro plate, Deep well plate with 200 ul, 450 ul 1 ml and 2 ml capacity but not limited to these.

In one embodiment, the use of some percentage of naturally occurring materials in the making of consumable products, especially by-product materials of certain processes and materials destined for landfills will reduce the mass, energy and waste materials needed to produce certain plastic products. In another embodiment, one may reduce the decomposition of materials in a land fill and reduce green gas production.

The composition and method of making the product using the composition disclosed herein may be implemented in any means for achieving various aspects. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a view of freezer box made up of biodegradable/bio-plastic materials.

FIG. 2 is a view of storage box for tubes made up of biodegradable/bio-plastic materials.

FIG. 3 is a view of the pipette tip rack made up of biodegradable/bio-plastic materials.

Other features of the present embodiments will be apparent from accompanying the detailed description that follows.

### DETAILED DESCRIPTION

The present invention is directed to the composition and use of this biodegradable bio-plastic material in several areas of life where disposable or reusable consumable products are made. More specifically we describe the use of this combination material in laboratory products. The consumable product is made out of this composition comprising of synthetic and natural material, first material and second material, more than one natural material or first material and more than one synthetic material, which may not be suitable for use in prolonged exposure to direct sun light. The composition is a mix of two or three materials and one of them is biodegradable bio-plastic reusable material and makes it possible for consumer products to be green and is beneficial for the environment in several key areas. A composition formulation for this biodegradable bio-plastic may be a percentage as follows, natural material or a hydrophilic material or any combination of either or both of them is between 0.001-20% , 25-50% , 0.001-51%, 25-51% by weight and or volume to make up 100%. If the material contains a synthetic material then the synthetic material portion is between 0.001-99% by weight and or volume is a total weight/volume of 100%. A formulation for this biodegradable bio-plastic material may be a percentage as follows, natural bio matter or a hydrophilic matter or any combination of greater than 0% and less than 80% by weight and or volume. The synthetic portion or the second natural material may be less than 100% and greater than 20% by weight and or volume.

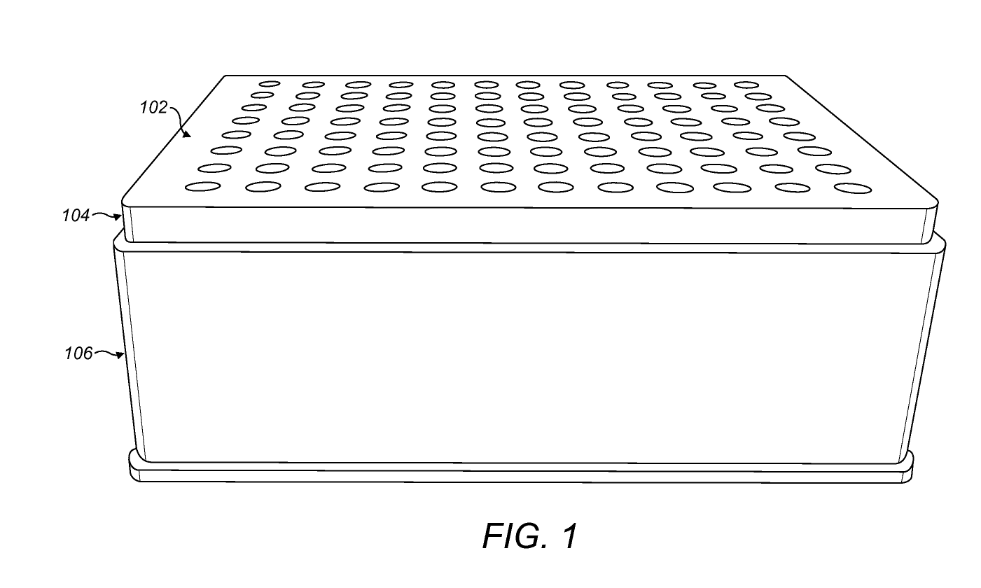

FIG. 1 for example shows a multipurpose freezer box. There are three components to it. Component 106 is the base and may be made up of biodegradable bio-plastic material that provides more rigidity hence the synthetic material may be present in more percentage and it may be reused for multiple storage containers. The biodegradable material may be a natural material or the second natural material or a combination of both. Component 104 may be made up of an equal or more natural material and/or second natural material based biodegradable material as shown in tables below. Component 102 may hold tubes or may be used for other intended purposes and may be a part of component 104 or be separate. All the three components may be made up of the same biodegradable composition as one another. The customization would depend on the customer and how they want to use the product. At no time it would be only synthetic material. The intent is to produce green materials that are easily biodegradable.

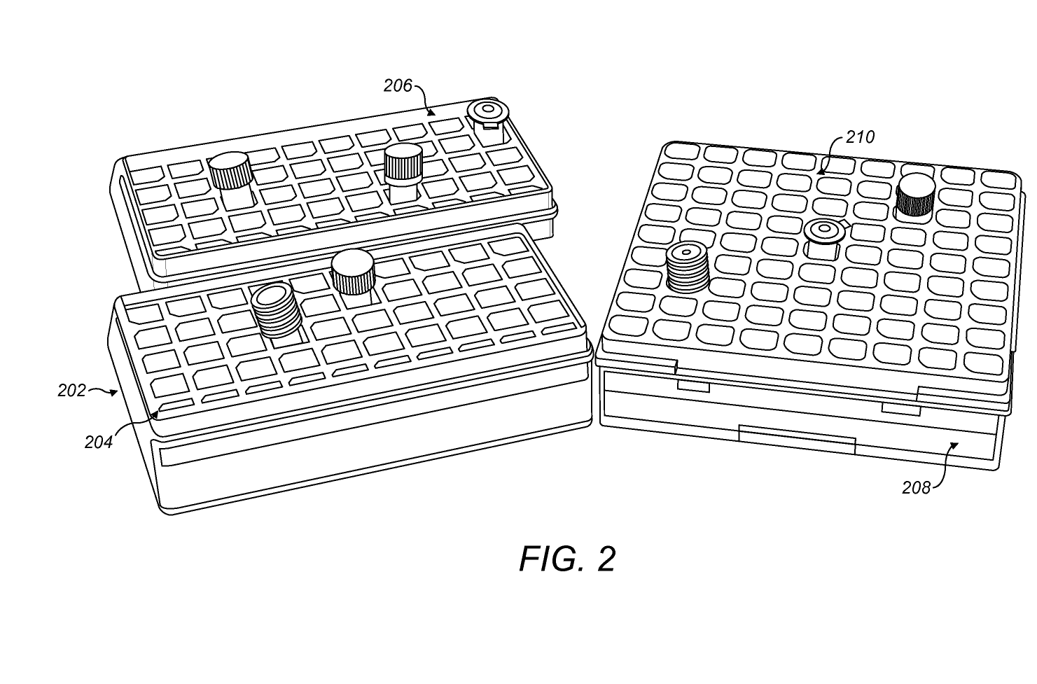

FIG. 2 shows various sizes of Eppendorf tube holders. Some as shown in component 202 and 204 may be made separately and of same or different biodegradable/bio-plastic materials. As shown in 206 it could be molded as one unit and made up of the same material. It really depends on the user how green they want to make their products and what their intended use is. As shown in component 208 and 210 since it is a large tube holder it may be used to make from more rigid materials and less percentage of natural materials. Some natural materials such as maple wood or rice husk may provide the necessary rigidity if it is used only for storage purpose and one may be a bit greener in ordering the product composition.

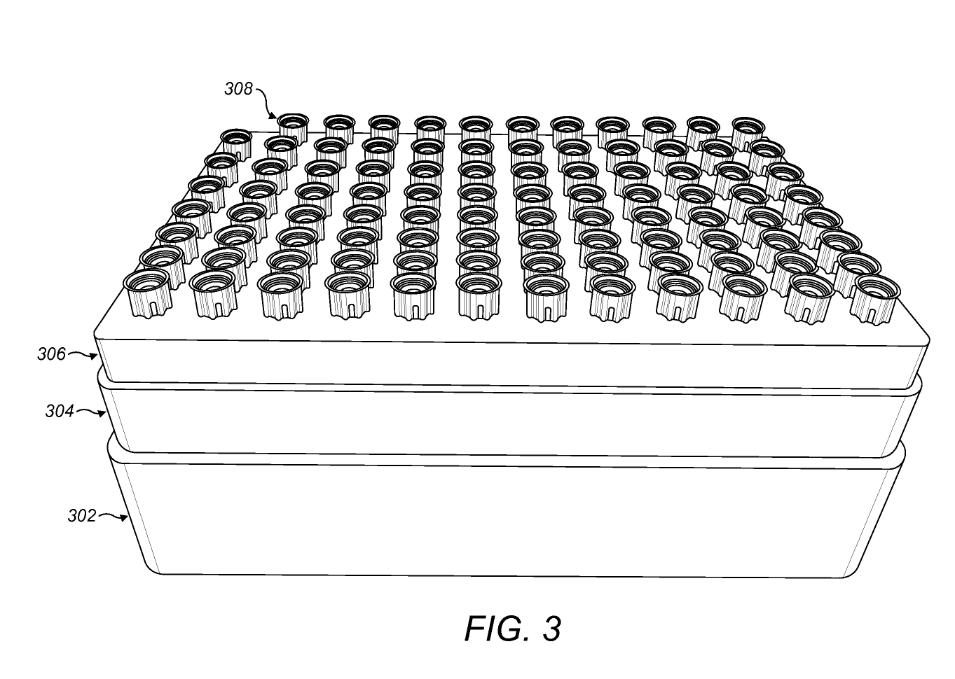

FIG. 3 shows essentially a different configuration of the tip holder box with tips in it. However, there are four variations. Component 302, 304 and 306 form the part of the box and may be molded from one type of combination of biodegradable/bio-plastic material or each one may be manufactured separately of different biodegradable material and assembled as one product. The pipette tips 308 may be made up of different biodegradable material than the holder and be used in the laboratory. These figures are only used for showing the differences that may be used in making these laboratory products. All material combination may be used to make Pipette packaging material, Micro centrifuge tube, Centrifuge tubes with 5 ml, 15 ml, 50 ml capacity, Screw cap sample storage tube, PCR sample tube, PCR strip, PCR plates 24 well, 48 well, 96 well, 384 well, 1536 well, Reservoir plate 1 well to 96 well, Assay plates 96 well, 384 well, 1536 well, 3456 well, 6144 well, Elisa micro plate, Deep well plate with 200 ul, 450 ul, 1 ml and 2 ml capacity. For example the microcentrifuge tube or the centrifuge tube may be made with the same biodegradable bio-plastic material as the body of that tube and cap are of different materials. The PCR strip or plates may be made with same or combination of biodegradable materials or more natural materials with a synthetic material just enough to provide stability and rigidity.

These laboratory products made of bio-plastic material will eventually end up in landfills and will biodegrade at an accelerated rate, especially plastics that are hydrophobic in nature like polypropylene and polyethylene. The mixture of a quick biodegradable hydrophilic material with a synthetic hydrophobic material will form a biofilm through the plastic parts more easily and quickly due to the formation of cavities and crevices within the entire plastic structure and wall sections of bio-plastic products. This key characteristic is very desirable in products that are disposable in nature like single use or short life products such as industrial and consumer packaging. For example pipette racks, storage racks, freezer racks, pipette tips, centrifuge tubes, storage tubes, screw cap storage tubes, and sample tubes such as PCR tubes, PCR plates, storage plates, micro plates, plastic box corner guards and some consumer products.

The natural portion of the bio-plastic composition is very flexible in its nature, as many materials that are sometimes by-products and discarded may be mixed with plastic to formulate the bio-plastic. Examples of such materials are walnut, almond, coconut and other hard shells, hard skins from rice, wheat, flax, and other seeds, corn husks, and other organic biodegradable matter. The Coconut Fiber has attributes such as stiffness, dimensional stability, hardness, odor free, low moisture absorption, lower specific gravity than minerals, and excellent chemical and mold resistance qualities. The following examples are some of the products that have been described but they are not just limited to these combinations. A formulation for this biodegradable/bio-plastic may be a percentage as follows, natural bio matter or hydrophilic matter such as cellulose based plastics, starch based plastic (PLA plastic), natural oil based plastics or other naturally derived hydrophilic plastics, or any combination of greater than 0% and less than 99% by weight and or volume. The plastic portion may be less than 100% and greater than 1% by weight and or volume. Several composition combinations have been discussed throughout the application and the composition is just not limited to those.

Plastic parts by the nature of the manufacturing process and by normal handling have a high static electricity change that is not desirable when two or more plastic parts are packaged together or when the plastics parts are used with flammable liquids. Light weight plastic parts when packaged together tend to be miss-aligned in a grid pattern due to static charge either during the manufacturing process, transportation process, during the handling of the plastic parts or in use in which two or more plastic parts rub against each other to produce the static charge.

A biodegradable material may comprise of a natural material having a specific tensile strength, wherein the natural material is biodegradable and a second natural material having a tensile strength, wherein the second natural material is plastic made up of a biodegradable material, to be mixed with the natural material in a specific weight ratio to produce the biodegradable material to make a laboratory product. Wherein the natural material is at least one of hydrophilic and hydrophobic in nature and the second natural material is hydrophilic in nature.

The specific weight ratio of the natural material may be 0.001% to 99.9% and the second natural material is 0.001% to 99.9%, wherein the specific weight is inversely proportional to each material. In another embodiment, the natural material is more than one type and the synthetic material is more than one type. The natural material is at least one of a walnut shell, almond shell, coconut and other hard shells, husk from rice, wheat, flax, starch, maple wood, other seeds, corn husks, and other organic biodegradable matter. The second natural material may be at least one of a cellulose based plastics, soy oil based bio plastic, zein (a protein based bio-plastic), protein based bio plastic, starch based plastic, polylactic acid based plastic (PLA), cornstarch based plastic, natural oil based plastics or other naturally derived hydrophilic plastic.

A biodegradable material may also comprise of a natural material having a mixture of at least one of a conducting property having material and a hydrophilic property having material; and a synthetic material having a hydrophobic property and a specific tensile strength and a specific combination ratio with a conductive property having material and the hydrophilic property having material to make the biodegradable material that may be used to make a laboratory product. The specific combinations may be 0.001% to 51% percentage of conductive property having material mixed with 0.001% to 49% one or more hydrophilic property having material and 0.001 to 99.9% of hydrophobic property having material. The material that has a conductive property may be coal and carbon derived from processed cellulose matter.

In some laboratory application of robotic pipetting machines the pipette tips need to be presented to the robotic machines in a grid that is aligned in rows of pipette tips for automatic processing. A biodegradable bio-plastic material may comprises of the first material, wherein the first material is a natural material having a hydrophilic property, a synthetic material having a hydrophobic property and a specific tensile strength and a specific combination ratio with the first material to make the biodegradable material that may be used to make a laboratory product. The specific combination is 0.001% to 51% percentage of first material having the conductive property mixed with 0.001% to 49% one or more hydrophilic property having material and 0.001 to 99.9% of hydrophobic property having material. The biodegradable material further comprises of a third material having a conductive property, wherein the third material is at least one of coal and carbon derived from processed cellulose matter. The hydrophilic property having material is at least one of a walnut shell, almond shell, coconut and other hard shells, husk from rice, wheat, flax, starch, other seeds, corn husks, and other organic biodegradable matter. The hydrophobic property having material is one of a cellulose based plastics, soy oil based bio plastic, zein (a protein based bio-plastic), protein based bio plastics, starch based plastic, polylactic acid based plastic (PLA), cornstarch based plastic, natural oil based plastics and combination thereof. Wherein the laboratory product is at least one of a Pipette tips, Pipette racks, Pipette rack covers both on top and bottom, Pipette packaging material, storage racks, freezer racks, Micro centrifuge tube, Centrifuge tubes with 5 ml, 15 ml, 50 ml capacity, Screw cap sample storage tube, PCR sample tube, PCR strip, PCR plates 24 well, 48 well, 96 well, 384 well, 1536 well, Reservoir plate 1 well to 96 well, Assay plates 96 well, 384 well, 1536 well, 3456 well, 6144 well, Elisa micro plate, Deep well plate with 200 ul, 450 ul, 1 ml and 2 ml capacity.

A mixture 0.001% to 51% percentage of conductive bio matter mixed with one or more hydrophilic matter containing 0.001% to 99.99% natural bio matter or hydrophilic matter such as cellulose based plastics, soy oil based bio plastic, zein (a protein based bio-plastic), protein based bio plastics, starch based plastic, polylactic acid based plastic (PLA), cornstarch based plastic, natural oil based plastics or other naturally derived hydrophilic plastics, or any combination thereof and a mixture of 0.001% to 99.99% synthetic plastics (second material) such as polypropylene, polyethylene, ABS, Poly styrene, Poly carbonate, Cyclic Olefin Copolymer (COC) and combination thereof. Synthetic plastics such as polypropylene, polyethylene, ABS, Poly styrene, Poly carbonate, Cyclic Olefin Copolymer (COC) to produce a bio friendly plastic along with a benefit of a static discharge or static dissipative properties. The biodegradable may have specific weight ratio of the natural material is 0.001% to 99.9% and the synthetic material is 0.001% to 99.0%.

The conductive material may be used for creating electrical conductance when used in laboratory consumables to perform laboratory tests such as electrophoresis, gas and liquid chromatography, the various biosensor devices that use proteins, DNA, antibodies, cells, and other biological particulates (such as PCR). Of critical importance to all of these techniques is the detection, monitoring, and transduction methods used to collect, observe, and interpret the signals, separation, or reaction generated by the device. Almost every method for energy transduction has been used to measure and observe signals in these various devices including optical, electrical, mechanical, thermal, chemical, magnetic, liquid level sensing and others. The biodegradable material having electrical conductance may be used as probes, pipette tips, cuvettes etc.

The addition of conductive material is important in many ways. One of the reasons is static dissipation during manufacturing; reduce buildup of static electricity during transportation and storage. The static build up may misalign the pipette tips or tubes and may change their position very slightly. If these misaligned boxes are used for automation and robotic arm pick then it might damage the robotic arm which has fixed x, y and z axis. The composition for static dissipation may be used for pipette racks, storage racks, freezer racks to avoid manufacturing malfunctions. In one embodiment, lesser the carbon material the resultant product becomes static resistive, typically the electrical readings read between 10⁵ to 10¹² ohms and if you add more carbon the plastic mix becomes conductive and the electrical reading read below 10⁵ ohms. Each material made in this way has a specific tensile strength as shown in the tables below.

### EXAMPLES

TABLE 1
Properties of Conductive material added biodegradable product:

| Properties | Test Method | Values | Units |
|---|---|---|---|
| Melt Flow rate, | D1238 | 18.00 | g/10 min |
| 230° C./2.160 kg | | | |
| Tensile strength | D 638 | 23 | MPa |
| Tensile Modulus | D 638 | 1448 | MPa |

Table 1 shows the combination of conductive material with a first material and second material. The first material may be a natural material or a synthetic material that is made from a natural material. Depending on the end product requirements, different formulations may be developed for the product requirements by using different hydrophilic matter. For example, laboratory products that don't come into contact with testing samples such as pipette racks may be formulated with natural by products. For sensitive research and development work such as for plants and for seed development, a starch based or natural oil based plastic may be used which is pure (loose contamination free) many be used to for the hydrophilic matter mixed with such plastics as polypropylene and polyethylene.

The natural portion of the bio-plastic composition is very flexible in its nature as many materials that are sometimes by-products and discarded may be mixed with plastic to formulate this plastic. Examples of such materials are walnut, almond, coconut and other hard shells, hard skins from rice, wheat, flax, and other seeds, corn husks, and other organic biodegradable matter.

TABLE 2
Second Natural materials based bio-plastic (for
example: Polypropylene and PLA bio-plastic):

| Properties | Test Method | Values | Units |
|---|---|---|---|
| Melt Flow rate, | ASTM D 1238 | 6.0 to 78 | g/10 min |
| 230° C./2.160 kg | | | |
| Tensile strength | ASTM D 638 | 3500-4000 | Psi (MPa) |
| | | (18-28) | |
| Density | ASTM D 792 | 0.95-0.90 | g/cm³ |

In one example a first material is having a specific tensile strength, wherein the first material is synthetic and a second material having a tensile strength, wherein the second material is a plastic made up of a natural material, to be mixed with the first material in a specific weight ratio to produce the biodegradable material to make a laboratory product.

TABLE 3
Coconut shell and Polypropylene mixed biodegradable material:

| Properties | Test Method | Values | Units |
|---|---|---|---|
| Melt Flow rate, | ISO 1133 | 17 | g/10 min |
| 230° C./2160 g | | | |
| Tensile strength | ISO 527 | 2610 (18) | Psi (MPa) |
| Density | ISO 1183 | 0.99 | g/cm³ |

TABLE 4
More Coconut Fiber combinations and properties:

| | 30% Fine Ground | 30% Coarse Ground | 40% Fine Ground | 40% Coarse Ground |
|---|---|---|---|---|
| | Coconut HI | Coconut HI | Coconut HI | Coconut HI |
| | Copolymer PP | Copolymer PP | Copolymer PP | Copolymer PP |
| Description | Natural/Black | Natural/Black | Natural/Black | Natural/Black |
| Filler Percentage | 30 | 30 | 40 | 40 |
| Density | 1.00 | 1.00 | 1.05 | 1.05 |
| Tensile Strength - PSI | 2,800 | 2,750 | 2,900 | 2,880 |
| Flexural Modulus - PSI | 180,000 | 175,000 | 225,000 | 210,000 |
| Izod Impact Ft/lb. - in | 2.0 | 2.0 | 1.5 | 1.5 |
| HDT @ 66 psi | 200 | 200 | 215 | 215 |
| HDT @ 264 psi | 125 | 125 | 130 | 130 |
| Mold Shrinkage | 0.009 | 0.009 | 0.007 | 0.007 |

A biodegradable bio-plastic material composition may comprise of a natural material such as walnut shell, almond shell, coconut and other hard shells, husk from rice, wheat, flax, starch, other seeds, corn husks, and other organic biodegradable matter; and a synthetic material such as polypropylene, polyethylene, ABS, Poly styrene, Poly carbonate or Cyclic Olefin Copolymer (COC) added in combination to make a laboratory product.

The flax fiber has attributes such as impact, stiffness, dimensional stability, low moisture absorption, excellent chemical and mold resistance, lower specific gravity than minerals and may be a good glass fiber replacement.

TABLE 5
Flax Fiber mixed biodegradable material and its property

| | 30% Flax Fiber | 50% Flax Fiber |
|---|---|---|
| | Reinforced | Reinforced |
| | Polypropylene | Polypropylene |
| Description | Copolymer | Copolymer |
| Filler Percentage | 30 | 30 |
| Density | 1.01 | 1.01 |
| Tensile Strength - PSI | 4,000 | 4,200 |
| Flexural Modulus - PSI | 375,000 | 480,000 |
| Izod Impact Ft/lb. - in | 0.9 | 0.5 |
| HDT @ 66 psi | 280 | 300 |
| HDT @ 264 psi | 175 | 220 |
| Mold Shrinkage | 0.007 | 0.007 |

The Rice husk also has stiffness, lower specific gravity than minerals, low moisture absorption, does not combust, excellent chemical and mold resistance, and is good for traditional mineral filled applications. Pine wood, reclaimed wood, walnut shell, etc., have similar property and are very amiable to form a biodegradable material with other hydrophilic synthetic material to enhance the quality of the product with superior tensile strength, high temperature usage and for chemical laboratory use since they are chemical resistance and do not react with internal contents. They may be easily degraded in soil and save the environment with pollution.

TABLE 6
Rice husk mixed biodegradable material and its property

| | 10% Rice Hull | 10% Rice Hull | | |
|---|---|---|---|---|
| | Reinforced | Reinforced, | | |
| | Polyolefin | recycled | 30% Rice Hull | 50% Rice Hull |
| | with 15% PC | content, | Reinforced | Reinforced |
| Description | Content | Polyolefin | Polypropylene | Polypropylene |
| Filler Percentage | 10 | 10 | 30 | 50 |
| Density | 0.95 | 0.96 | 1.03 | 1.13 |
| Tensile Strength - PSI | 2,700 | 3,300 | 3,600 | 3,400 |
| Flexural Modulus - PSI | 145,000 | 150,000 | 285,000 | 440,000 |
| Izod Impact Ft/lb. - in | 4.0 | 2.2 | 0.8 | 0.5 |
| HDT @ 66 psi | 185 | 190 | 255 | 290 |
| HDT @ 264 psi | 130 | 135 | 135 | 175 |
| Mold Shrinkage | 0.010 | 0.011 | 0.007 | 0.006 |

TABLE 7
Walnut shell mixed biodegradable material and its property

| | 30% Coarse | 50% Coarse |
|---|---|---|
| | Ground Walnut | Ground Walnut |
| | Reinforced | Reinforced |
| Description | Polypropylene | Polypropylene |
| Filler Percentage | 30 | 50 |
| Density | 1.00 | 1.08 |
| Tensile Strength - PSI | 3,200 | 3,900 |
| Flexural Modulus - PSI | 230,000 | 380,000 |
| Izod Impact Ft/lb. - in | 1.0 | 0.5 |
| HDT @ 66 psi | 235 | 280 |
| HDT @ 264 psi | 140 | 180 |
| Mold Shrinkage | 0.009 | 0.007 |

TABLE 8
Maple wood mixed biodegradable material and its property:

| | 30% Maple | | 50% Maple |
|---|---|---|---|
| | Wood Rein- | 30% Maple | Wood Rein- |
| | forced Poly- | Wood Rein- | forced Poly- |
| | propylene | forced Poly- | propylene |
| Description | Copolymer | olefin | Copolymer |
| Filler Percentage | 30 | 30 | 50 |
| Density | 1.02 | 1.02 | 1.10 |
| Tensile Strength - PSI | 4,400 | 4,300 | 5,500 |
| Flexural Modulus - PSI | 365,000 | 350,000 | 690,000 |
| Izod Impact Ft/lb. - in | 1.1 | 1.2 | 0.7 |
| HDT @ 66 psi | 265 | 270 | 300 |
| HDT @ 264 psi | 165 | 180 | 225 |
| Mold Shrinkage | 0.007 | 0.007 | 0.006 |

TABLE 9
Pine wood mixed biodegradable material and its property:

| | 30% Pine | 30% Pine | |
|---|---|---|---|
| | Wood Rein- | Wood Rein- | 50% Pine |
| | forced Poly- | forced Poly- | Wood Filled |
| Description | propylene | olefin | Copolymer |
| Filler Percentage | 30 | 30 | 50 |
| Density | 1.02 | 1.02 | 1.11 |
| Tensile Strength - PSI | 4,000 | 4,100 | 4,600 |
| Flexural Modulus - PSI | 400,000 | 420,000 | 735,000 |
| Izod Impact Ft/lb. - in | 0.7 | 0.7 | 0.5 |
| HDT @ 66 psi | 275 | 270 | 300 |
| HDT @ 264 psi | 165 | 165 | 230 |
| Mold Shrinkage | 0.007 | 0.007 | 0.006 |

Typical manufacturing methods that may be used to make consumable biodegradable articles from this bio-plastic are injection molding, injection blow molding, extrusion, compression molding, co-extrusion, thermoforming and rotational molding, but not limited to only these procedures. The use of some percentage of naturally occurring materials in the making of consumable products, especially by-product materials of certain processes and materials destined for landfills will reduce the mass, energy and way materials needed to produce certain plastic products. For example, if a pen requires 100 grams of plastic to be manufactured normally, the substitution of 5 grams of naturally occurring bio material will save 5 grams in plastic and energy that would have gone into the manufacture of each pen. One may use these materials in pens, test tube racks, pipette holders, cold storage racks and boxes, glass wear drying tray and baskets, shopping bags, sheets to cover picnic tables, children toys etc.

In addition, it will be appreciated that the various embodiments, materials, and compositions may be interchangeable used in the current embodiments and various combinations of the article of use. Accordingly, the specification and drawings are to be regarded in an illustrative rather than a restrictive sense.

What is claimed is:

1. A biodegradable bio-plastic material, comprising:
a first material having a specific tensile strength, wherein the first material is synthetic;
and
a second material having a tensile strength, wherein the second material is a plastic made up of a natural material, to be mixed with the first material in a specific weight ratio to produce the biodegradable material to make a laboratory product.

2. The biodegradable material of claim 1, wherein the first material is at least one of a hydrophobic and hydrophilic in nature.

3. The biodegradable material of claim 1, wherein the second natural material is at least one of a hydrophobic and hydrophilic in nature.

4. The biodegradable material of claim 1, wherein specific weight ratio of the first material is 0.001% to 99.9% and the second material is 0.001% to 99.9%, wherein the specific weight ratio is inversely proportional to other material.

5. The biodegradable material of claim 1, wherein the first material is more than one type and the second material is more than one type that is present in the biodegradable material.

6. The biodegradable material of claim 5, wherein the first material is at least one of a polypropylene, polyethylene, ABS, Poly styrene, Poly carbonate, Cyclic Olefin Copolymer (COC) and combination thereof.

7. The biodegradable material of claim 5, wherein the second material, that is made from the natural material, is at least one of a cellulose based plastics, soy oil based bio plastic, zein (a protein based bio-plastic), protein based bio plastic, starch based plastic, polylactic acid based plastic (PLA), cornstarch based plastic, natural oil based plastics or other naturally derived hydrophilic plastic.

8. The biodegradable material of claim 1, wherein the laboratory product is at least one of a Pipette tips, Pipette racks, Pipette rack covers both on top and bottom, Pipette packaging material, storage racks, freezer racks, Micro centrifuge tube, Centrifuge tubes with 5 ml, 15 ml, 50 ml capacity, Screw cap sample storage tube, PCR sample tube, PCR strip, PCR plates 24 well, 48 well, 96 well, 384 well, 1536 well, Reservoir plate 1 well to 96 well, Assay plates 96 well, 384 well, 1536 well, 3456 well, 6144 well, Elisa micro plate, Deep well plate with 200 ul, 450 ul 1 ml and 2 ml capacity.

9. A biodegradable bio-plastic material, comprising:
a first material, wherein the first material is a natural material having a hydrophilic property; and
a synthetic material having a hydrophobic property and a specific tensile strength and a specific combination ratio with the first material to make the biodegradable material that may be used to make a laboratory product.

10. The biodegradable material of claim 9, wherein the specific combination is 0.001% to 51% percentage of first material having the conductive property mixed with 0.001% to 49% one or more hydrophilic property having material and 0.001 to 99.9% of hydrophobic property having material.

11. The biodegradable material of claim 9, further comprising:
a third material having a conductive property, wherein the third material is at least one of coal and carbon derived from processed cellulose matter.

12. The biodegradable material of claim 9, wherein the hydrophilic property having material is at least one of a walnut shell, almond shell, coconut and other hard shells, husk from rice, wheat, flax, starch, other seeds, corn husks, and other organic biodegradable matter.

13. The biodegradable material of claim 9, wherein the hydrophobic property having material is one of a cellulose based plastics, soy oil based bio plastic, zein (a protein based bio-plastic), protein based bio plastics, starch based plastic, polylactic acid based plastic (PLA), cornstarch based plastic, natural oil based plastics and combination thereof.

14. The biodegradable material of claim 9, wherein the laboratory product is at least one of a Pipette tips, Pipette racks, Pipette rack covers both on top and bottom, Pipette packaging material, storage racks, freezer racks, Micro centrifuge tube, Centrifuge tubes with 5 ml, 15 ml, 50 ml capacity, Screw cap sample storage tube, PCR sample tube, PCR strip, PCR plates 24 well, 48 well, 96 well, 384 well, 1536 well, Reservoir plate 1 well to 96 well, Assay plates 96 well, 384 well, 1536 well, 3456 well, 6144 well, Elisa micro plate, Deep well plate with 200 ul, 450 ul, 1 ml and 2 ml capacity.

15. The biodegradable material of claim 11, wherein the laboratory product is at least one of a Pipette tips, Pipette racks, Pipette rack covers both on top and bottom, Pipette packaging material, storage racks, freezer racks, Micro centrifuge tube, Centrifuge tubes with 5 ml, 15 ml, 50 ml capacity, Screw cap sample storage tube, PCR sample tube, PCR strip, PCR plates 24 well, 48 well, 96 well, 384 well, 1536 well, Reservoir plate 1 well to 96 well, Assay plates 96 well, 384 well, 1536 well, 3456 well, 6144 well, Elisa micro plate, Deep well plate with 200 ul, 450 ul, 1 ml and 2 ml capacity.

16. A biodegradable bio-plastic material composition, comprising:
a natural material such as walnut shell, almond shell, coconut and other hard shells, husk from rice, wheat, flax, starch, other seeds, corn husks, and other organic biodegradable matter; and
a synthetic material such as polypropylene, polyethylene, ABS, Poly styrene, Poly carbonate or Cyclic Olefin Copolymer (COC) added in combination to make a laboratory product.

17. The biodegradable bio-plastic material composition claim of 16, wherein the natural material is hydrophilic in nature and the synthetic material is hydrophobic in nature.

18. The biodegradable bio-plastic material composition claim of 16, further comprising:
The biodegradable bio-plastic material composition has a specific tensile strength.

19. The biodegradable bio-plastic material composition of claim 16, wherein the laboratory product is at least one of a Pipette tips, Pipette racks, Pipette rack covers both on top and bottom, Pipette packaging material, storage racks, freezer racks, Micro centrifuge tube, Centrifuge tubes with 5 ml, 15 ml, 50 ml capacity, Screw cap sample storage tube, PCR sample tube, PCR strip, PCR plates 24 well, 48 well, 96 well, 384 well, 1536 well, Reservoir plate 1 well to 96 well, Assay plates 96 well, 384 well, 1536 well, 3456 well, 6144 well, Elisa micro plate, Deep well plate with 200 ul, 450 ul, 1 ml and 2 ml capacity.
